(19) United States
(12) Patent Application Publication
(10) Pub. No.: US 2009/0157626 A1
(43) Pub. Date: Jun. 18, 2009

(54) SYSTEM AND METHOD FOR AUTOMATICALLY UPDATING PATENT EXAMINATION PROCEDURES

(75) Inventors: CHUNG-I LEE, Tu-Cheng (TW); HAI-HONG LIN, Shenzhen City (CN); DE-YI XIE, Shenzhen City (CN); ZHENG-CAI ZHU, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY(Shenzhen) CO., LTD., Shenzhen City (CN); HON HAI PRECISION INDUSTRY CO., LTD., Tu-Cheng (TW)

(21) Appl. No.: 12/238,413

(22) Filed: Sep. 25, 2008

(30) Foreign Application Priority Data
Dec. 17, 2007 (CN) 200710203145.1

(51) Int. Cl. G06F 7/06; G06F 17/30

(52) U.S. Cl. 707/3; 707/200; 707/102; 707/E17.005; 707/E17.044; 707/E17.014

(57) ABSTRACT

A computer-implemented method for updating patent examination procedures automatically is provided. The method includes determining whether an examination procedure of a patent stored in a database needs to be updated by monitoring a status of the patent, obtaining an application country information and an application number of the patent from the database, accessing a patent website corresponding to the application country information to search examination information of the patent in the patent website. The method further includes determining whether the examination information of the patent has been changed, downloading new examination information of the patent from the patent website according to the application number of the patent, if the examination information of the patent has been changed, and uploading the new examination information of the patent to the database to update the examination procedure of the patent.

### BACKGROUND

1. Field of the Invention

Embodiments of the present disclosure relate to patent information management, and more particularly to systems and methods for automatically updating patent examination procedures.

2. Description of Related Art

Patents are becoming more and more important to business success, especially in today's globalized economy. A good way to make use of patents is to search and analyze public patent databases, which are storehouses of up-to-date technological information. The patent databases provide not only technical information about patents, but also information on official documents of the patents. The official documents of the patents are used by applicants to know examination procedures of the patents. The examination procedures may include patent publications, procedural reviews, substantial reviews, patent announcements, and so on. Presently, in order for applicants to obtain these official documents, the applicants may receive the official documents by an Email, and manually update the official documents to a local database. However, such manual updating way is a very difficult, tedious, and time-consuming task.

What is needed is an improved system and method for automatically updating patent examination procedures.

### SUMMARY

A computer-implemented method for updating patent examination procedures automatically is provided. The method includes: determining whether an examination procedure of a patent stored in a database needs to be updated by monitoring a status of the patent; obtaining an application country information and an application number of the patent from the database, if the examination procedure of the patent needs to be updated; accessing a patent website corresponding to the application country information of the patent to search examination information of the patent in the patent website; determining whether the examination information of the patent has been changed; downloading new examination information of the patent from the patent website according to the application number of the patent, if the examination information of the patent has been changed; and uploading the new examination information of the patent to the database to update the examination procedure of the patent.

Other advantages and novel features will become more apparent from the following detailed description certain embodiments of the present disclosure when taken in conjunction with the accompanying drawings.

### BRIEF DESCRIPTION OF THE DRAWINGS

FIG. 1 is a schematic diagram of one embodiment of a system for updating patent examination procedures automatically;

FIG. 2 is a block diagram of one embodiment of the application server 1 of FIG 1; and

FIG. 3 is a flowchart of one embodiment of a method for updating patent examination procedures automatically.

### DETAILED DESCRIPTION OF CERTAIN INVENTIVE EMBODIMENTS

All of the processes described below may be embodied in, and fully automated via, software code modules executed by one or more general purpose computers or processors. The code modules may be stored in any type of computer-readable medium or other computer storage device. Some or all of the methods may alternatively be embodied in specialized computer hardware.

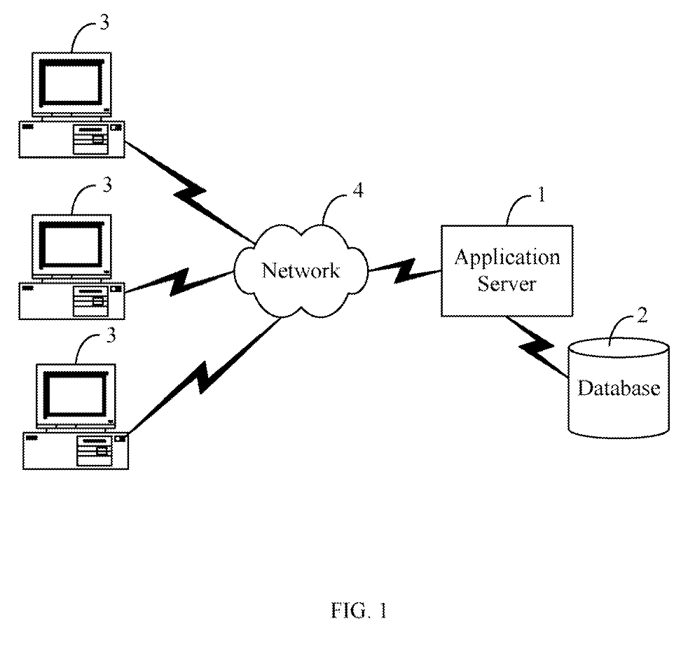

FIG. 1 is a schematic diagram of one embodiment of a system for updating patent examination procedures automatically (hereinafter, “the system”). The system typically includes an application server 1 and a database 2. The database 2 electronically connects with the application server 1, and is used for storing information about patent examination procedures. The application server 1 is coupled to one or more patent websites 3 (only three patent websites 3 are shown in FIG. 1) via the Internet 4. The application server 1 is used for monitoring statuses of the patents stored in the database 2, downloading new examination information of the patents from each of the patent websites 3 to update the examination procedures of the patents.

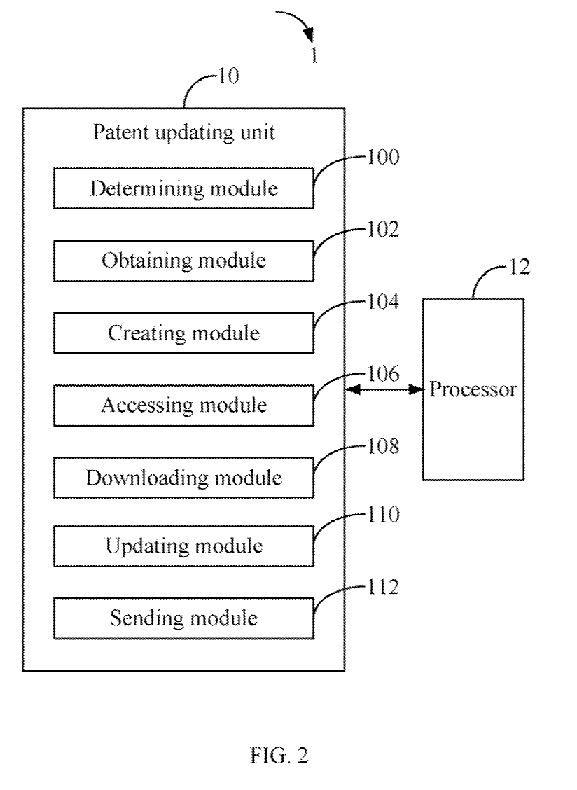

FIG. 2 is a block diagram of one embodiment of the application server 1 of FIG 1. The application server 1 may comprise a patent updating unit 10 and at least one processor 12. The patent updating unit 10 may be a software program including a plurality of instructions, and executed by the processor 12 of the application server 1. In one embodiment, the patent updating unit 10 may include a determining module 100, an obtaining module 102, a creating module 104, an accessing module 106, a downloading module 08, an updating module 110 and a sending module 112.

The determining module 100 is configured for determining whether examination procedures of the patents need to be updated by monitoring statuses of the patents in the database 2.

The obtaining module 102 is configured for obtaining application country information and application numbers of the patents from the database 2 if the examination procedures of the patents need to be updated.

The creating module 104 is configured for creating a patent list according to the application country information and the application numbers of the patents, and storing the patent list into the database 2.

The accessing module 106 is configured for accessing the patent websites 3 according to the application country information of the patent list, so as to search examination information of the patents in the patent websites 3. In the embodiment, the examination information may be information about various patent examination procedures of one or more patents. The patent websites 3 may be the United States Patent and Trademark Office (USPTO) website, the European Patent Office (EPO) website, the State Intellectual Property Office of P.R China (SIPO) website, the Taiwan Intellectual Property Office (TIPO) website, etc.

The determining module 100 is also configured for determining whether the examination procedures of the patents have been changed by comparing the examination information in the patent websites 3 with the examination procedures stored in the database 2. In one embodiment, the determining module 100 may determine that the examination procedures have been changed if the examination information is different from the examination procedures stored in the database 2. In another embodiment, if the examination information is the same as the examination procedures in the database 2, the determining module 10 determines the examination procedures are the same.

The downloading module 108 is configured for downloading new examination information of the patents from the corresponding patent websites 3 according to the application numbers in the patent list.

The updating module 110 is configured for uploading the new examination information of the patents to the database 2 to update the examination procedures of the patents.

The sending module 112 is configured for sending the updated examination procedures of the patents to related person.

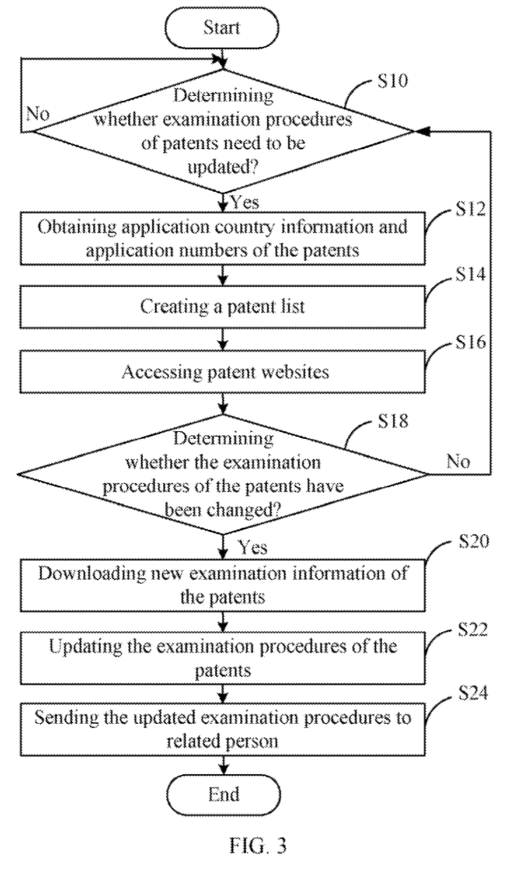

FIG. 3 is a flowchart of one embodiment of a preferred method for updating patent examination procedures automatically by implementing the system of FIG. 1 as described above. Depending on the embodiment, additional blocks may be added, others removed, and the ordering of the blocks may be changed.

In block S10, the determining module 100 determines whether the examination procedures of the patents need to be updated by monitoring statuses of the patents in the database 2.

In block S12, the obtaining module 102 obtains application country information and application numbers of the patents from the database 2.

In block S14, the creating module 104 creates a patent list according to the application country information and the application numbers, and stores the patent list into the database 2.

In block S16, the accessing module 106 accesses the corresponding patent websites 3 according to the application country information of the patent list, so as to search the examination information of the patents in the corresponding patent websites 3. For example, if one of the application country information indicates the United States, the accessing module 106 may access the USPTO website to search examination information of the patents.

In block S18, the determining module 100 determines whether the examination procedures have been changed by comparing the examination information in the patent website 3 with the examination procedures stored in the database 2. If the examination information is different from the examination procedures stored in the database 2, the determining module 100 may determine the examination procedures have been changed, and the flow may move to block S20. Otherwise, if the examination information is the same as the examination procedures in the database 2, the determining module 10 determines the examination procedures are the same, and the flow may return the block S10.

In block S20, the downloading module 108 downloads new examination information of the patents from the corresponding patent websites 3 according to the application numbers in the patent list.

In block S22, the updating module 110 uploads the new examination information of the patents to the database 2 to update the examination procedures of the patents.

In block S24, the sending module 112 sends the updated examination procedures of the patents to related person.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for updating patent examination procedures automatically, the method comprising:
determining whether an examination procedure of a patent stored in a database needs to be updated by monitoring a status of the patent;
obtaining an application country information and an application number of the patent from the database, if the examination procedure of the patent needs to be updated;
accessing a patent website corresponding to the application country information of the patent to search examination information of the patent in the patent website;
determining whether the examination information of the patent has been changed;
downloading new examination information of the patent from the patent website according to the application number of the patent, if the examination information of the patent has been changed; and
uploading the new examination information of the patent to the database to update the examination procedure of the patent.

2. The method as claimed in claim 1, further comprising:
creating a patent list according to the application country information and the application number of the patent, and storing the patent list into the database.

3. The method as claimed in claim 1, further comprising:
comparing the examination information of the patent with the examination procedure of the patent stored in the database.

4. The method as claimed in claim 1, further comprising:
sending the updated examination procedure of the patent to related person.

5. A system for updating patent examination procedures automatically comprising:
a determining module configured for determining whether examination procedures of patents stored in a database need to be updated by monitoring statuses of the patents;
an obtaining module configured for obtaining application country information and application numbers of the patents from the database;
an accessing module configured for accessing a corresponding patent website according to the application country information of the patents, and searching examination information of the patents in the patent website;
the determining module also configured for determining whether the examination procedures of the patents have been changed by comparing the examination information of the patents with the examination procedures stored in the database;
a downloading module configured for downloading new examination information of the patents from the corresponding patent website according to the application numbers;
an updating module configured for uploading the new examination information of the patents to the database to update the examination procedures of the patents; and
at least one processor that executes the determining module, the obtaining module, the accessing module, the downloading module, and the updating module.

6. The system as claimed in claim 5, wherein the application server further comprises a creating module configured for creating a patent list according to the application country information and the application numbers of the patents, and storing the patent list into the database.

7. The system as claimed in claim 5, wherein the application server further comprises a sending module configured for sending the updated examination procedures of the patents to related person.

8. A computer-readable medium having stored thereon instructions, the computer-readable medium, when executed by a computer, causing the computer to perform a method for updating patent examination procedures automatically, the method comprising:
determining whether an examination procedure of a patent stored in a database needs to be updated by monitoring a status of the patent;
obtaining an application country information and an application number of the patent from the database, if the examination procedure of the patent needs to be updated;
accessing a patent website corresponding to the application country information of the patent to search examination information of the patent in the patent website;
determining whether the examination information of the patent has been changed;
downloading new examination information of the patent from the patent website according to the application number of the patent, if the examination information of the patent has been changed; and
uploading the new examination information of the patent to the database to update the examination procedure of the patent.

9. The medium as claimed in claim 8, wherein the method further comprises:
creating a patent list according to the application country information and the application numbers of the patents, and storing the patent list into the database.

10. The medium as claimed in claim 8, wherein the method further comprises:
comparing the examination information of the patent with the examination procedure of the patent stored in the database.

11. The medium as claimed in claim 8, wherein the method further comprises:
sending the updated examination procedure of the patent to related person.
